(19) United States
(12) Patent Application Publication
(10) Pub. No.: US 2008/0245565 A1
(43) Pub. Date: Oct. 9, 2008

(54) Device for Connecting a Basic Electrical Component and an Additional Electrical Component to a Supply Network, Especially of a Motor Vehicle, and Methods for the Production of Such a Connecting Device

(75) Inventor: Thomas Bielesch, Muhlacker (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/630,375

(22) PCT Filed: Jun. 22, 2005
(86) PCT No.: PCT/EP2005/006721

§ 371 Date: Feb. 11, 2008

(30) Foreign Application Priority Data
Jun. 24, 2004 (DE) 10 2004 030 698.2

(51) Int. Cl. H01B 7/00; H01R 43/04

(52) U.S. Cl. 174/72 A; 29/866

(57) ABSTRACT

The invention relates to a device for connecting a basic electrical component and an additional electrical component to a supply network, especially of a motor vehicle, and several methods for producing such a connecting device. Said device comprises at least one first contact to which the supply network can be connected, at least one second contact to which the basic electrical component can be connected, and at least one third contact to which the additional electrical component can be connected. The contacts are connected in an electrically conducting manner with the aid of at least one flat conductor. At least the first and the third contact are formed by a terminal section of the flat conductor. The terminal section of the flat conductor which forms the contact is bent in such a way that the first and the third contact are oriented in a given direction, particularly a horizontal or vertical direction.

The present invention relates to a device for connecting a basic electrical component, such as an electrical control device or an electrical drive, to a line network, especially of a motor vehicle, and to a plurality of methods for the production of such a (connecting) device.

Such a connecting device, a plug-in or plug system for connecting an I/I component, such as an (electrical) drive of an electric fan, for example for a cooling system for engine cooling of a motor vehicle or for an air conditioning system for the interior air conditioning of a motor vehicle, to a vehicle power supply system of the motor vehicle, is known from the prior art.

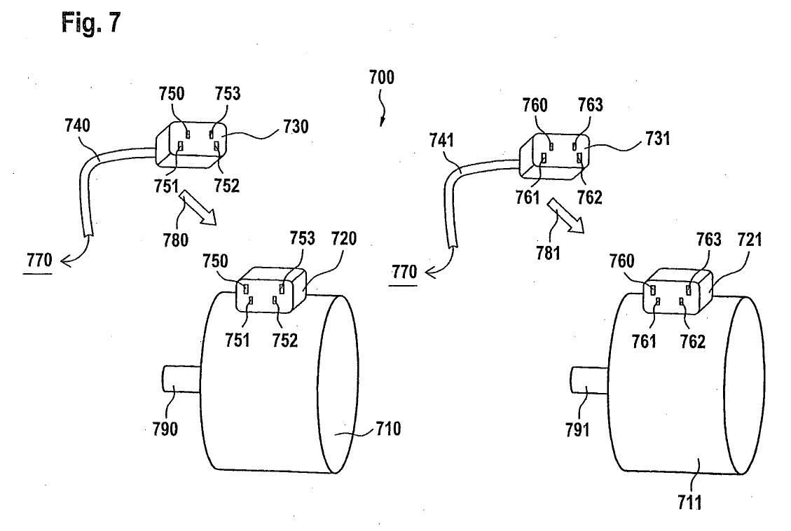

FIG. 7 illustrates such a plug-in system 780 or 781 from the prior art for a dual-fan system 700 of a motor vehicle cooling module.

With this dual-fan system 700, two electrical drive units or motors 710, 711, each having this plug-in system 780, 781 known from the prior art, of a four-pole plug-in or plug connection, with which contact can be made on one side, are connected to a vehicle power supply system 770 of a motor vehicle.

The plug-in system 780, 781 comprises two plug-in parts, with each of which contact can be made on one side or which can be plugged one inside the other, a three-pole or, as is illustrated by way of example, four-pole vehicle power supply system plug 730 or 731, with which contact can be made on one side, and an associated three-pole or, as illustrated by way of example, four-pole mating plug 720 or 721, with which contact can likewise be made on one side.

The vehicle power supply system plug 730 or 731 is connected to the vehicle power supply system 770 via a cable 740 or 741. The mating plug 720 or 721 is integrated in the electrical drive motor 710 or 711, as a result of which the electrical drive motor 710 or 711 is connected to the mating plug 720 or 721 corresponding to the cable 740 or 741 or such a connection.

In the case illustrated, the cable 740 or 741 combines four lines, two lines being used for the main current supply, in this case (+/−) feed lines of a battery supply.

The other two lines are control and bus lines, more generally signal or communication signal lines, of a vehicle electronic system.

In terms of the control of the respective drive, the same applies to the integrated connection between the mating plug 720 or 721 and the respective drive motor 710 or 711.

When contact has been made with the plug-in system 780 or 781 or plug-in parts 730 or 731 and 720 or 721 have been plugged one inside the other, the connection between the vehicle power supply system and the (respective) drive 710 or 711 is produced via four pole contacts 750 to 753 or 760 to 763, as a result of which the drive 710 or 711 is supplied with energy and control and communication signals.

On the basis of these signals, the respective drive shaft 790 or 791 is caused to rotate, and this rotation is transferred to a fan impeller or a blower impeller.

One disadvantage with this dual-fan system 700 having two drive units 710 and 711, which are connected to the vehicle power supply system 700 via plug-in connections 780 or 781, with each of which contact can be made on one side, is the fact that contact is made between each drive unit 710 or 711 and the vehicle power supply system 700 separately, in which case an increased degree of complexity in terms of wiring and/or installation with correspondingly high costs and known electrical and electronic disadvantages is necessary.

Some fan drives are controlled by correspondingly complex interfaces, with the result that, here, a higher number of connection lines, in particular control lines and/or bus systems, are required per fan drive. The corresponding wiring complexity for the entire fan system is thus correspondingly increased.

Furthermore, with such fan drives which are more complex and have additional control lines and increased wiring complexity, further-reaching measures are required for decoupling the individual fan drives or fan systems with respect to communication and in order to be able also to control them individually. This further entails disadvantages as regards ease of diagnosis.

Correspondingly disadvantageously, this also applies in simple and, on an even larger scale, in more complex multi-function fan systems in which it is necessary to make contact between a large number of fans or fan drives and a vehicle power supply system in each case separately by means of the plug-in connection, with which contact can be made on one side, such as from the prior art.

The invention is therefore based on the object of providing a plug system, generally a connecting device, for connecting an electrical component, such as an electrical drive or else an actuator, to a line network, which connecting device makes possible simple and cost-effective wiring of the electrical components with a low degree of complexity in terms of wiring and installation.

Furthermore, a modular design, comprising a plurality of electrical components, such as comprising a plurality of fan systems and actuators, should be made possible.

Furthermore, with the invention the above further disadvantages in more complex multi-function systems, such as fan systems, in particular in multi-function fan systems, should be avoided.

These objects are achieved by the device for connecting a basic electrical component and an additional electrical component to a line network, especially of a motor vehicle, and by the methods for the production of such a device having the features in accordance with the respective independent patent claim.

Preferred embodiments and developments are the subject matter of the dependent claims.

The device according to the invention for connecting a basic electrical component and an additional electrical component to a line network, especially of a motor vehicle, has at least one first contact, to which the line network can be connected, at least one second contact, to which the basic electrical component can be connected, and at least one third contact, to which the additional electrical component can be connected.

In this case, a contact will be understood below to mean a functional element for making electrical contact, for example a plug contact or a plug contact element, especially a contact pin, of a single-pole or multi-pole plug or else a corresponding mating piece, such as a contact socket for receiving a contact pin.

By means of such contact-making, especially a main current contact, for example for a power supply, or a signal contact, especially for transmission of a communication signal, can be realized.

Furthermore, a line will be understood below to mean any type of signal, power and/or data line and a line network will be understood to mean an associated superordinate unit of such lines. The line network according to the invention may in this case be, for example, a power supply system or a communications network, especially a bus system or a control network.

The contacts of the device according to the invention are electrically conductively connected using at least one flat conductor, for example a metallic flat conductor, especially based on copper.

In this case, flat conductors will be understood to mean especially flat electrically conductive bodies, which are substantially elongate in a main longitudinal direction.

At least the first and the third contact are each formed by an end section of the at least one flat conductor, the respective end section, which forms the contact, of the flat conductor being bent such that the first and the third contact each have a predeterminable, especially a horizontal or vertical, alignment in each case with respect to a main longitudinal direction of the at least one flat conductor.

Angled bends with any desired alignment with respect to the main longitudinal direction are also possible.

Corresponding bending tools and/or corresponding processing methods for producing the bend starting from a correspondingly shaped basic body, i.e. the flat conductor in the unbent state, are selected according to the predeterminable alignment and are known to a person skilled in the art.

In the text which follows, an end section of a flat conductor is also understood to be a three-dimensionally extending region at one end of the flat conductor.

As can be seen from the drawings, the device according to the invention realizes a plug (dual-pin plug), with which contact can be made on a plurality of sides and whose contact connections can be realized by a flat conductor, which is bent at least partially in the end region.

Bending of the respective end sections such that the first and the third contact each have a horizontal or vertical alignment with respect to a main longitudinal direction of the at least one flat conductor is preferred here since the most common types of contact for electrical drives, in particular for cooler fans or air conditioning blowers, i.e. plugs with a horizontal and vertical contact arrangement, can thus be realized.

The plug with which contact can be made on a plurality of sides can be connected to the line network, for example to a vehicle power supply system of a motor vehicle, via a first main contact connection, in this case the first contact, and to the basic electrical component, such as an electrical drive, via a second main contact connection, in this case the second contact.

Provision may preferably be made here for integrating the second contact in the basic electrical or electronic component, for example in the electrical drive, especially in an electric motor, in an actuator, for example a resilient material element, or in an electronic control or regulation device.

The basic electrical component can thus be connected to the line network via these main contact connections.

Furthermore, the plug, with which contact can be made on a plurality of sides, can be connected to a further electrical component, the additional component, for example also an electrical drive, especially an electric motor, or an actuator, for example a resilient material element, or an electronic control or regulation device, via a third contact connection, in this case the third contact.

Via this third contact connection of the plug, with which contact can be made on a plurality of sides, the additional electrical component—or when using a plurality of such plugs according to the invention in series, a plurality of additional components—can likewise be connected to the line network.

A multi-function fan system can thus be realized in which a large number of fans or their input motors are connected indirectly or directly in parallel with the at least one line network in each case by means of the plug according to the invention, with which contact can be made on a plurality of sides, or in each case by means of the dual-pin plug according to the invention.

The device also has the advantage that, with it, it is possible to realize the most common types of contact for cooler fans or air conditioning blowers, i.e. (multi-pole) (multiway) plugs having a horizontal and/or vertical contact arrangement. In this case, a number of poles and a contact arrangement or alignment can be varied according to the invention.

In this case, provision may then be made for the respective end section, which forms the contact, of the at least one flat conductor to be bent such that the first and the third contact have the same predeterminable alignment.

This can be realized in a simple manner especially when the two end sections of the first and the third contact are connected directly to one another, in this case the two end sections being capable of being bent at the same time.

It is also possible for the end sections to be bent differently and accordingly for the alignments of the contacts (to the line network and to the additional component) to differ. Provision may thus be made, for example, for the contact to the line network to be aligned horizontally or vertically and for the contact to the additional component to be aligned vertically or horizontally.

In one preferred development, the end section, which forms the first contact, of the at least one flat conductor and the end section, which forms the third contact, of the at least one flat conductor are opposite edges of a substantially plate-like end piece of the at least one flat conductor.

Preferably—especially for realizing multi-pole multiway plugs—in one development a plurality of flat conductors and/or a plurality of first, second and third contacts may be provided, each of which is formed by an end section of a flat conductor. In this case, provision may further be made for at least one first one of the plurality of flat conductors to electrically conductively connect only two contacts, especially the first contact and the third contact, and/or for at least one second one of the plurality of flat conductors to electrically conductively connect all three contacts, i.e. the first, second and third contact.

In one further preferred development, devices according to the invention are used for cooling and/or air conditioning, especially of a motor vehicle interior or a motor vehicle cooling module, the basic electrical component being an electrical drive, especially an electric motor of an electric fan or air conditioning blower.

In one further preferred development, the device is a multi-pole, especially a two-, three- or four-pole plug-in system, especially a multi-pole dual-pin plug, a corresponding number of in each case first, second and/or third contacts being provided corresponding to the number of poles.

In the method for the production of a device according to the invention for connecting a basic electrical component and an additional electrical component to a line network, especially of a motor vehicle, the end section, which forms the first and/or the third contact, of the at least one flat conductor is bent such that the first and/or the third contact is or are each provided with the predeterminable alignment, especially the vertical or horizontal alignment, with respect to the main longitudinal direction of the at least one flat conductor.

In order to protect the flat conductor, it may have material, especially a plastic, injected around it, in general be sheathed or enveloped, at least partially or else as a whole. As a result, it is possible to realize a (plastic) housing in a simple manner.

It is also thus possible to produce simple and cost-effective plastic plug-in connections, in the case of horizontal or vertical contacts, for the most customary types of contact connections for electric motors, especially for cooler fans.

With the device according to the invention and developments thereof, especially in the form of a multi-pole multiway or dual-pin plug, the following tasks inter alia, can be realized or fulfilled—even next to one another—depending on the design:

A first plug of this type in the form of a main connection plug to a vehicle power supply system having corresponding main current supply lines and control lines or bus lines can thus be realized which connects a first electrical unit, the basic component, to the vehicle power supply system.

As subsequent connection or further-connection plugs, by means of such plugs further drive units or subsystems, such as actuators, having corresponding main current, control and bus lines can be connected to the vehicle power supply system.

The contacts for making contact with control and bus lines may be in the form of bidirectional inputs or outputs. They can then be used as sensor inputs, bus or control lines for external components, such as a shutter or a resilient material element, for example.

The control or bus lines can also be used for encoding purposes for the respective drive (example: right-hand/left-hand drive). Intelligent integration in a failsafe concept for the fan system (shutter) can be realized.

A connection of further drives using a multi-core additional line can be realized.

In addition to the abovedescribed advantages, the device according to the invention and developments thereof also have the following further advantages:

A multi-pole multiway plug for connecting drive systems to a vehicle power supply system, which supplies the drive systems with battery voltage and control lines, can be realized in a cost-effective manner.

All current bus systems from a very wide variety of manufacturers or customers can be realized by a plug system in accordance with the device according to the invention, for example a PWM interface both with terminal 15/87 driving and without terminal 15/87 driving, a CAN bus or a LIN bus system.

With only one at least four-pole plug in accordance with the device according to the invention, two drives, for example for two fans, can be driven separately using two PWM input signals.

In particular, the device according to the invention and developments thereof can reduce the wiring complexity, for example in the case of a vehicle electronic system.

The production method according to the invention and developments thereof moreover allow for cost-effective manufacture of the device according to the invention, especially of a (multiway) plug system according to the invention.

Given corresponding design and software modification, the invention enables communication of drive systems directly with one another or with the vehicle system (vehicle electronic system).

A second connection plug according to the invention, for example on a second drive unit, can also be used, if required, only on one side (for connection to the first connection plug according to the invention which is used on two sides on the first drive unit). In this case, the second plug side can be sealed by plastic or can be equipped with a dummy plug.

Furthermore, by means of the invention, thermomanagement of a module and of a fan system can be taken on by integrating software in the drives.

Contacts of the input or main connection plug in comparison with contacts of the output or further-connection plug can be connected to various drive inputs or drive outputs, with the result that they can be driven or input independently of one another.

Furthermore, protective systems, such as blocking protection, a failsafe mode and/or diagnosis—in this case in the form of a diagnosis plug or diagnosis contact—can be integrated in the drive by the invention.

Further advantages, features and possible applications of the present invention result from the description below relating to exemplary embodiments in connection with the figures, in which:

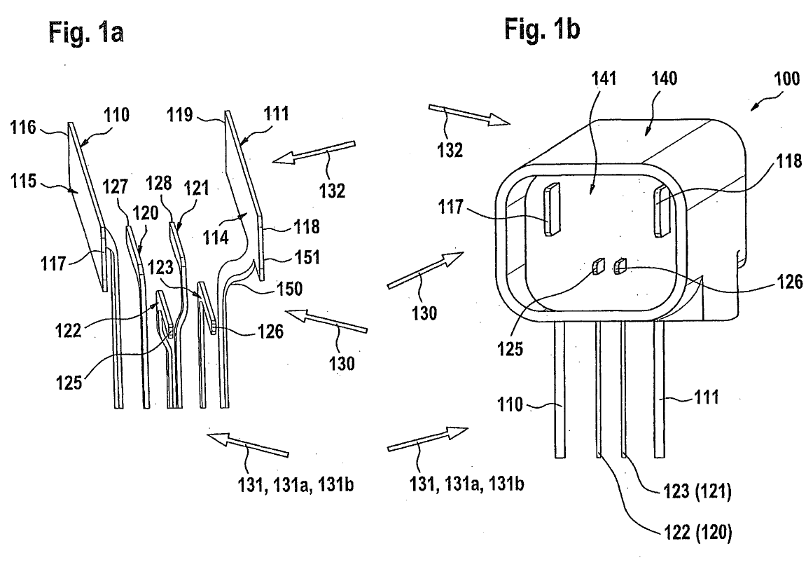

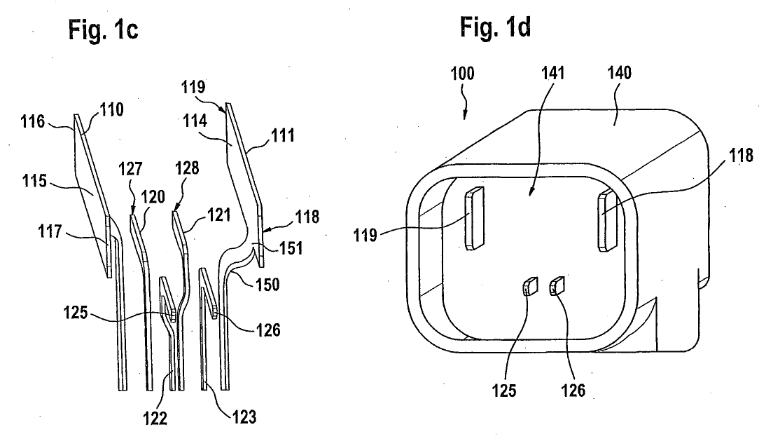

FIGS. 1a to d show sketches of a dual-pin plug having vertically arranged flat conductor contacts or main current and signal contacts in accordance with a first exemplary embodiment according to the invention;

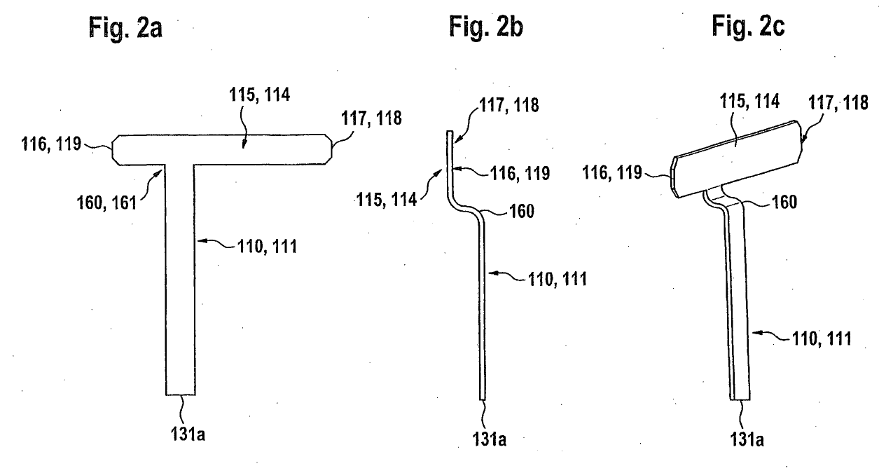

FIGS. 2a to c show sketches of a vertically arranged main current contact of a dual-pin plug having vertically arranged flat conductor contacts in accordance with a first exemplary embodiment according to the invention;

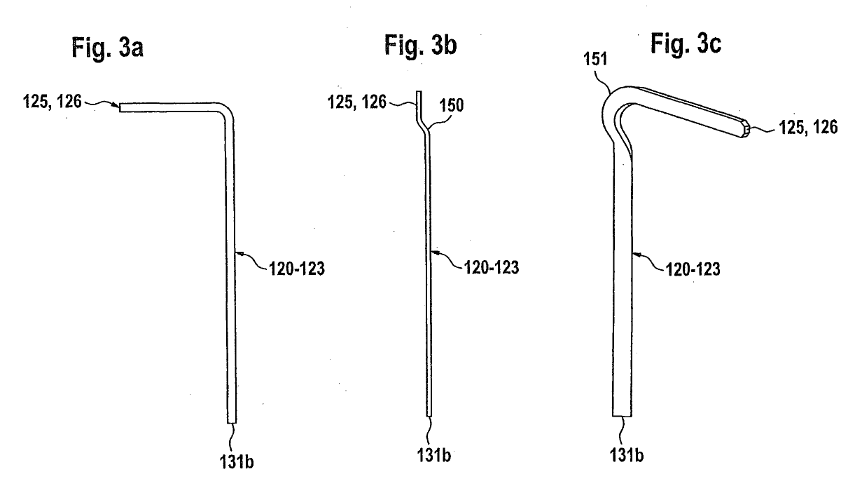

FIGS. 3a to c show sketches of a vertically arranged signal contact of a dual-pin plug having vertically arranged flat conductor contacts in accordance with a first exemplary embodiment according to the invention;

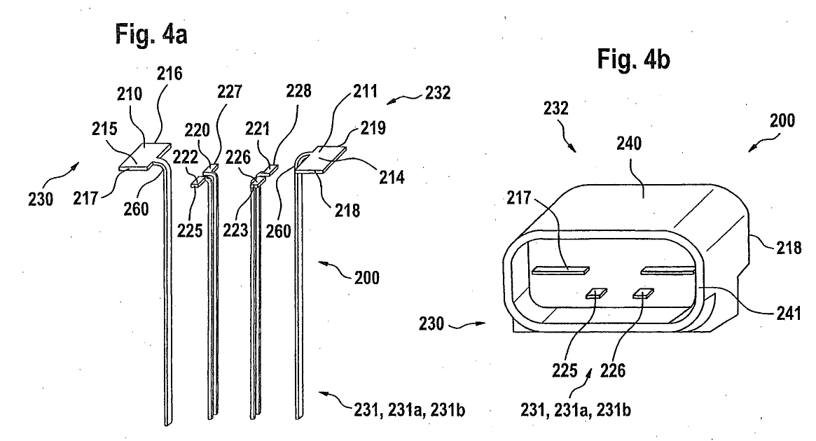

FIGS. 4a and b show sketches of a dual-pin plug having horizontally arranged flat conductor contacts or main current and signal contacts in accordance with a second exemplary embodiment according to the invention;

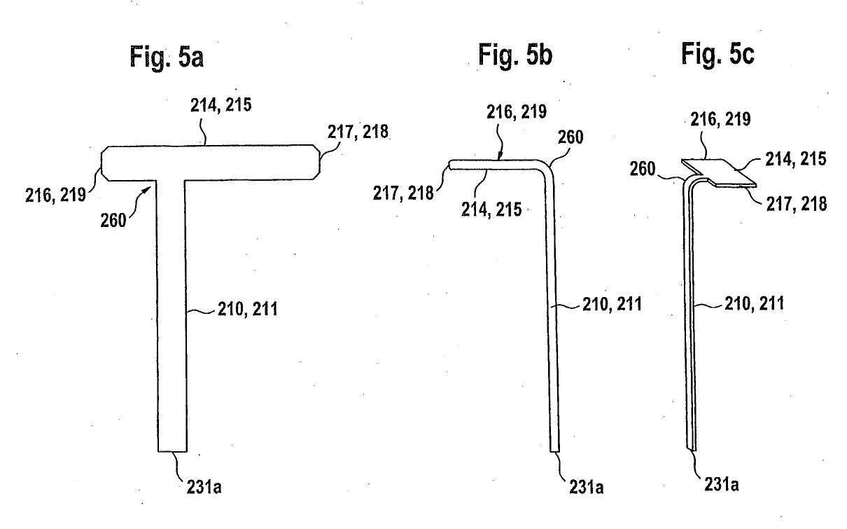

FIGS. 5a to c show sketches of a horizontally arranged main current contact of a dual-pin plug having horizontally arranged flat conductor contacts in accordance with a second exemplary embodiment according to the invention;

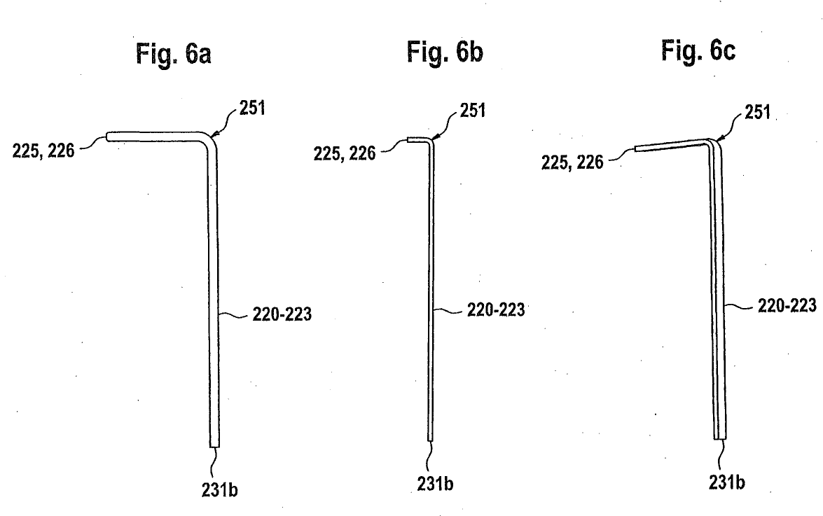

FIGS. 6a to c show sketches of a horizontally arranged signal contact of a dual-pin plug having horizontally arranged flat conductor contacts in accordance with a second exemplary embodiment according to the invention;

FIG. 7 shows a sketch of a dual-fan system having plug-in connections, with which contact can be made on one side, in accordance with the prior art; and

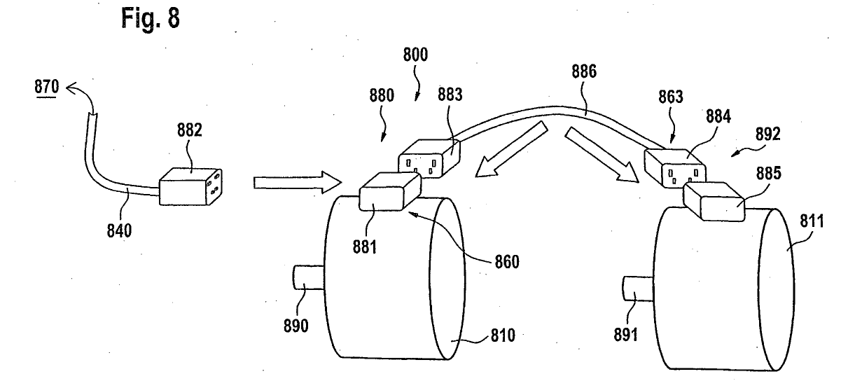

FIG. 8 shows a sketch of a dual-fan system, in which the fan systems are connected to a vehicle power supply system by means of dual-pin plugs according to the invention.

A first exemplary embodiment of the invention, a four-pole dual-pin plug 100 having vertically arranged flat conductor contacts or vertically arranged main current and signal contacts, will now be described with reference to FIGS. 1 to 3.

Here, FIGS. 1a and c show the flat conductor arrangements comprising the main current and signal contacts of the dual-pin plug 100, in an overview; FIGS. 2a to 2c show, in two side views and a 3 D view, the flat conductor forming the main current contact, in detail; FIGS. 3a to c show, in two side views and a 3 D view, the flat conductor forming the signal contact, in detail. In FIGS. 1b and d, the flat conductors, around which a plastic is injected so as to form a plug housing, of the dual-pin plug 100 are illustrated.

The four-pole dual-pin plug 100 can be used in the frame of a dual fan system for connecting a first electric fan and a second electric fan to a vehicle power supply system, as shown in FIG. 8.

As shown in FIGS. 1a and c, the flat conductor arrangement comprises a plurality of flat conductors 110, 111 and 120 to 123, which are bent at the ends. These flat conductors 110, 111 and 120 to 123, which are bent at their ends, in this case have the vertically arranged flat conductor contacts 117, 118 and 125, 126 for the input contact connection 130 and the vertically arranged flat conductor contacts 116, 119 and 127, 128 for the output contact connection 132.

Via the input contact connection 130, the dual-pin plug 100 is connected to the vehicle power supply system; via the output contact connection 132, the dual-pin plug is connected to the second electric fan or the second electric fan is connected to the vehicle power supply system.

The flat conductors 110 and 111 or their contacts 116 to 119 form two-pole main current contacts to a power supply; the flat conductors 120 to 123 or their contacts 125 to 128 form two-pole signal contacts for control and communication signals. In total, this gives the four poles of the dual-pin plug in accordance with the embodiment.

The flat conductors 110, 111 for the main current contacts are designed such that a substantially elongate, flat and stem-shaped basic body at one end becomes, via a transition region 160 bent in the form of an S, a substantially flat, plate-shaped body 114, 115, as shown in FIGS. 1a and c and FIGS. 2a to c.

This substantially flat, plate-shaped body 114, 115 with a substantially rectangular base is aligned vertically, as shown in FIGS. 1a and c and 2a to c. A front plate end or edge region and a rear plate end or edge region, which is opposite the front plate end or edge region, form the contact and connection points 130, 132 of the main current contacts 116 to 119 to the vehicle power supply system and the second electric fan.

The respective other end, which is opposite the plate-shaped body 114, 115, of the flat conductors 110, 111 forms part of the contact connection 131, in this case the main current contact connection 131a, to the first electric fan, as a result of which the first electric fan is connected to the vehicle power supply system via the flat conductors 110, 111.

In accordance with this embodiment, this main current contact connection 131a, as the entire contact connection 131, is integrated in the first electric fan, but can also alternatively be in the form of a plug-in contact corresponding to the input contact connection 130 or output contact connection 132.

The flat conductors 120 to 123 for the signal contacts 125 to 128 are designed such that a substantially overall elongate, flat and stem-shaped body has, at one end, a transition region 150, which is bent in the form of an S and then becomes a substantially right-angled bend 151, as shown in FIGS. 1a and c and FIGS. 3a to c.

The end region, emerging from the bend, of the flat conductor is aligned vertically, as shown in FIGS. 1a and c and 2a to c, and forms the contact and connection points 130, 132 of the signal contacts 125 to 128 to the vehicle power supply system (125, 126) and the second electric fan (127, 128).

The respective other end, which is opposite the signal contacts 125 to 128, of the flat conductors 120 to 123 forms part of the contact connection 131, in this case the signal contact connection 131b, to the first electric fan, as a result of which the first electric fan is connected to the vehicle power supply system via the flat conductors 122, 123.

Signals are passed on from the first electric fan to the second electric fan via the other two flat conductors 120, 121, as a result of which this second electric fan is also connected to the vehicle power supply system.

In accordance with this embodiment, this signal contact connection 131b is integrated in the first electric fan, but can also alternatively be in the form of a plug-in contact corresponding to the input contact connection 130 or output contact connection 132.

FIGS. 1b and d show the flat conductors 110, 111 and 122, 123 integrated in a plug housing 140.

In order to produce the plug housing 140, plastic is injected approximately entirely around the flat conductors 110, 111 and 120 to 123. Only the contacts 116 to 119 and 125 to 128 are not surrounded by the plastic at their end, the actual contact points for making contact.

Correspondingly shaped injection molding dies provide the housing with the shape illustrated, in particular the shaping of the slots for the connection plug to the vehicle power supply system and the connection plug for connection to the second electric fan.

The arrows 130, 131 and 132 illustrated identify these connections, the input contact connection 130 to the vehicle power supply system, the output contact connection 132 to the second electric fan and the connection contact to the first electric fan.

In particular, FIGS. 1b and 1d show here the slot 141 for the input contact connection 130, i.e. the direct connection to the vehicle power supply system, in detail.

As can further be seen from FIGS. 1b and d, the main current contacts 118, 119 (also the main current contacts 116, 117 which cannot be seen) and the signal contacts 125, 126 (also the signal contacts 127, 128 which cannot be seen) are arranged vertically, as a result of which conventional connection plugs for producing a plug-in connection, in this case for making the connection contact to the vehicle power supply system 130 and for making the further contact to the second electric fan 132, can be used.

A second exemplary embodiment of the invention, a four-pole dual-pin plug 200 having horizontally arranged flat conductor contacts or horizontally arranged main current and signal contacts, will now be described with reference to FIGS. 4 to 6.

First, note should be made here of the fact that dual-pin plugs 200 described below correspond to the above-described dual-pin plug 100 in terms of its operation and substantially in terms of its design. Corresponding elements are therefore correspondingly identified from the last two figures of the respective reference symbols.

A substantial difference between the two dual-pin plugs 100 and 200 is the alignment of the contacts of the flat conductors, which are aligned vertically in the case of the dual-pin plug 100 as described above and horizontally in the case of the dual-pin plug 200. The bends in the flat conductors correspond to the respective alignment of the contacts.

FIG. 4a shows the flat conductor arrangements comprising the main current and signal contacts of the dual-pin plug 200, in an overview; FIGS. 5a to c show, in two side views and a 3 D view, the flat conductor forming the main current contact, in detail; FIGS. 6a to c show, in two side views and a 3 D view, the flat conductor forming the signal contact, in detail. In FIG. 1b, the flat conductors, around which a plastic is injected so as to form a plug housing, of the dual-pin plug 200 are illustrated.

The four-pole dual-pin plug 200 can be used, in a corresponding manner to the dual-pin plug 100 and as shown in FIG. 8, in the frame of a dual fan system for connecting a first electric fan and a second electric fan to a vehicle power supply system.

As is shown in FIG. 4a, the flat conductor arrangement comprises a plurality of flat conductors 210, 211 and 220 to 223, which are bent at the ends. These flat conductors 210, 211 and 220 to 223, which are bent at their ends, in this case have the horizontally arranged flat conductor contacts 217, 218 and 225, 226 for the input contact connection 230 and the horizontally arranged flat conductor contacts 21b, 219 and 227, 228 for the output contact connection 232.

Via the input contact connection 230, the dual-pin plug 200 is connected to the vehicle power supply system; via the output contact connection 232, the dual-pin plug is connected to the second electric fan or the second electric fan is connected to the vehicle power supply system.

The flat conductors 210 and 211 or their contacts 216 to 219 form two-pole main current contacts to a power supply; the flat conductors 220 to 223 or their contacts 225 to 228 form two-pole signal contacts for control and communication signals. In total, this gives the four poles of the dual-pin plug 200 in accordance with the embodiment.

The flat conductors 210, 211 for the main current contacts are designed such that a substantially elongate, flat and stem-shaped basic body at one end becomes, via a substantially right-angled bend 260, a substantially flat, plate-shaped body 214, 215, as shown in FIG. 4a and FIGS. 5a to c.

This substantially flat, plate-shaped body 214, 215 with a substantially rectangular base is aligned horizontally, as shown in FIGS. 4a and 5b to c. A front plate end or edge region and a rear plate end or edge region, which is opposite the front plate end or edge region, form the contact and connection points 230, 232 of the main current contacts 216 to 219 to the vehicle power supply system and the second electric fan.

The respective other end, which is opposite the plate-shaped body 214, 215, of the flat conductors 210, 211 forms part of the contact connection 231, in this case the main current contact connection 231a, to the first electric fan, as a result of which the first electric fan is connected to the vehicle power supply system via the flat conductors 210, 211.

In accordance with the embodiment, this main current contact connection 231a, as the entire contact connection 231, is integrated in the first electric fan, but can alternatively be in the form of a plug-in contact corresponding to the input contact connection 230 or output contact connection 232.

The flat conductors 220 to 223 for the signal contacts 225 to 228 are designed such that a substantially overall elongate, flat and stem-shaped body at one end becomes a substantially right-angled bend 251, as shown in FIG. 4a and FIGS. 6a to c.

The end region, emerging from the bend 251, of the flat conductor is aligned horizontally, as shown in FIGS. 4a and 6a to c, and forms the contact and connection points 230, 232 of the signal contacts 225 to 228 to the vehicle power supply system (225, 226) and the second electric fan (227, 228).

The respective other end, which is opposite the signal contacts 225 to 228, of the flat conductors 220 to 223 forms part of the contact connection 231, in this case the signal contact connection 231b, to the first electric fan, as a result of which the first electric fan is connected to the vehicle power supply system via the flat conductors 222, 223.

Signals are passed on from the first electric fan to the second electric fan via the other two flat conductors 220, 221, as a result of which the second electric fan is also connected to the vehicle power supply system.

In accordance with the embodiment, this signal contact connection 231b is integrated in the first electric fan, but can alternatively be in the form of a plug-in contact corresponding to the input contact connection 230 or output contact connection 232.

FIG. 4b shows the flat conductors 210, 211 and 222, 223 integrated in a plug housing 240.

In order to produce the plug housing 240, plastic is injected approximately entirely around the flat conductors 210, 211 and 220 to 223. Only the contacts 216 to 219 and 225 to 228 are not surrounded by the plastic at their end, the actual contact points for making contact.

Correspondingly shaped injection molding dies provide the housing with the shape illustrated, in particular the shaping of the slots for the connection plugs to the vehicle power supply system and the connection plug for the connection to the second electrical fan.

The arrows 230, 231 and 232 illustrated identify these connections, the input contact connection 230 to the vehicle power supply system, the output contact connection 232 to the second electric fan and the connection contact to the first electric fan.

In particular, FIG. 4b shows here the slot 241 for the input contact connection 230, i.e. the direct connection to the vehicle power supply system, in detail.

As can further be seen from FIG. 1b, the main current contacts 218, 219 (also the main current contacts 216, 217 which cannot be seen) and the signal contacts 225, 226 (also the signal contacts 227, 228 which cannot be seen) are arranged horizontally, as a result of which conventional connection plugs for producing a plug-in connection, in this case for making connection contact to the vehicle power supply system 230 and for making the further contact to the second electric fan 232, can be used.

FIG. 8 shows a sketch of a dual fan system 800, as can be used in a vehicle cooling module, in which the fan systems are connected to a vehicle power supply system 870 by means of dual-pin plug systems 880, 892 having dual-pin plugs 881, 885 according to the invention.

The dual-pin plugs 881, 885 used here are realized with vertically arranged flat conductor contacts, in accordance with the dual-pin plugs shown in FIGS. 1 to 3. However, such dual-pin plugs in accordance with FIGS. 4 to 6 having horizontally arranged flat conductor contacts can also be used. The following embodiments should be interpreted accordingly.

In this dual fan system 800 in FIG. 8, two electrical drive units or motors, a first drive 810 and a second drive 811, are connected to the vehicle power supply system 870 using the dual-pin plug systems 880, 892.

The dual-pin plug systems 880, 892 in this case each comprise, as the central element, the four-pole dual-pin plug 881, 885, with which contact can be made on two sides and which is integrated in the respective drive 810, 811.

The first drive 810 is connected to the vehicle power supply system 870 via a four-pole vehicle power supply system plug 882, which is connected to the vehicle power supply system 870 via a cable 840, the dual-pin plug 881, which enters into a plug-in connection with the vehicle power supply system plug 882, and the integrated connection, via which the dual-pin plug 881 is connected to the first drive 810.

The cable 840 combines four lines—corresponding to the four poles—two lines being used for the main current supply, in this case (+/−) feed lines of a battery supply. The other two lines are control and bus lines of a vehicle electronic system.

The first drive 810 is supplied with energy and control and communication signals via these lines. On the basis of these signals, the drive shaft 890 is caused to rotate, and this rotation is transferred to a blower impeller or fan impeller.

Furthermore, the plug-in connection 880 comprises a first four-pole connection plug 883, which is fitted to one end 862 of a connection cable 886 and enters into a plug-in connection with the dual-pin plug 881. Arranged at the other end 863 of the connection cable 886 is a second connection plug 884, which is part of the plug-in connection 892 and enters into a plug-in connection there with the dual-pin plug 885.

The connection cable 886 is designed so as to correspond to the (vehicle power supply system) cable 840 and likewise combines the four lines.

The dual-pin plug 885 of the four-pole plug-in or plug connection 892 is integrated in the second drive 811, as a result of which the second drive 811 is connected to the vehicle power supply system 870 and, as a result, is supplied with energy and control and communications signals.

On the basis of these signals, the drive shaft 890 is caused to rotate, and this rotation is transferred to a blower impeller or fan impeller.

1. A device for connecting a basic electrical component and an additional electrical component to a line network, especially of a motor vehicle:
having at least one first contact, to which the line network can be connected, having at least one second contact, to which the basic electrical component can be connected, and having at least one third contact, to which the additional electrical component can be connected,
the first, second and third contact being electrically conductively connected using at least one flat conductor,
at least the first and the third contact each being formed by an end section of the at least one flat conductor,
the respective end section, which forms the contact, of the at least one flat conductor being bent such that the first and the third contact each have a predeterminable alignment.

2. The device as claimed in claim 1 wherein:
the respective end section, which forms the contact, of the at least one flat conductor is bent such that the first and/or the third contact has or have a vertical or horizontal alignment with respect to a main longitudinal direction of the at least one flat conductor or an angled bend with any desired alignment with respect to the main longitudinal direction.

3. The device as claimed in claim 1, wherein:
the respective end section, which forms the contact, of the at least one flat conductor is bent such that the first and the third contact have the same predeterminable alignment.

4. The device as claimed in claim 1, wherein:
the end section, which forms the first contact, of the at least one flat conductor and the end section, which forms the third contact, of the at least one flat conductor are opposite edges of a substantially plate-like end piece of the at least one flat conductor.

5. The device as claimed in claim 1, wherein:
the first, second and/or the third contact is or are a main current contact, especially for a power supply, or a signal contact, especially for transmission of a communication signal.

6. The device as claimed in claim 1 wherein:
the second contact is integrated in the basic electrical component.

7. The device as claimed in claim 1, wherein:
the line network is a power supply system or a communications network, especially a bus system or a control network.

8. The device as claimed in claim 1, wherein:
the basic electrical component and/or the additional electrical component is or are an I/I component, a control device or an electrical drive, especially for a fan or blower, or an actuator, especially one which can be used in each case in a motor vehicle.

9. The device as claimed in claim 1, wherein:
plastic is injected around at least part of the at least one flat conductor, as a result of which a housing is formed.

10. The device as claimed in claim 1 wherein:
the at least one flat conductor is produced from a metal based on copper.

11. The device as claimed in claim 1, wherein:
having a plurality of flat conductors and/or having a plurality of first, second and third contacts, each of which is formed by an end section of a flat conductor, at least one first one of the plurality of flat conductors electrically conductively connecting only two contacts, especially the first contact and the third contact, and/or at least one second one of the plurality of flat conductors electrically conductively connecting the first, second and third contact.

12. The device as claimed in claim 1, wherein:
the device is used directly or indirectly for cooling and/or air conditioning, especially of a motor vehicle interior or of a motor vehicle cooling module or of a motor vehicle engine, the basic electrical component being an I/I component, a control device or an electrical drive, especially an electric motor of an electric fan or air conditioning blower.

13. The device as claimed in claim 1, wherein
the device is a multi-pole, especially a two-, three- or four-pole plug-in system, especially a multi-pole dual-pin plug, a corresponding number of in each case first, second and/or third contacts being provided corresponding to the number of poles.

14. A method for the production of a device for connecting a basic electrical component and an additional electrical component to a line network, especially of a motor vehicle, as claimed in claim 1, wherein:
the end section, which forms the first and/or third contact, of the at least one flat conductor is bent such that the first and/or the third contact is or are each provided with the predeterminable alignment, especially the vertical or horizontal alignment, with respect to the main longitudinal direction of the at least one flat conductor.

15. The method as claimed in claim 14, wherein material, in particular a plastic, is injected around the at least one flat conductor.
